(19) United States
(12) Patent Application Publication
(10) Pub. No.: US 2019/0188621 A1
(43) Pub. Date: Jun. 20, 2019

(54) PRODUCT NARROWING DOWN SUPPORT SYSTEM AND METHOD

(71) Applicant: Hitachi, Ltd., Tokyo (JP)

(72) Inventor: Hiroaki NASU, Tokyo (JP)

(21) Appl. No.: 16/200,715

(22) Filed: Nov. 27, 2018

(30) Foreign Application Priority Data
Dec. 18, 2017 (JP) 2017-241416

(51) Int. Cl. G06Q 10/06

(52) U.S. Cl. CPC G06Q 10/06315

(57) ABSTRACT

A product narrowing down support system in an enterprise dealing with various kinds of goods, includes a processing unit and a storage unit, in which the storage unit stores, a product master table storing various kinds of goods, a management index database storing a management index of the enterprise and data thereof for each product, and a factor index database storing a factor index for each department affected by multiple products and data thereof for each product, and the processing unit narrows down a product which greatly influences deterioration in the management index for each management index by VC crossing to specify a product of a target for which a measure is to be implemented.

### CLAIM OF PRIORITY

The present application claims priority from Japanese patent application JP 2017-241416 filed on Dec. 18, 2017, the content of which is hereby incorporated by reference into this application.

### BACKGROUND OF THE INVENTION

### 1. Field of the Invention

The present invention relates to a product narrowing down support system, and more particularly, to a narrowing down support technology of a product having a high influence degree on the entire value chain (hereinafter, referred to as VC) such as department crossing in enterprises dealing with various kinds of goods.

### 2. Description of the Related Art

In recent years, enterprises deal with a small quantity and various kinds of goods are getting increased due to diversity of customer needs. However, when dealing with a small quantity and various kinds of goods, many enterprises are worried about operations in each process department becoming complicated and a profit not coming out as expected. However, in order to solve management problems that are intertwined with the complicated problems, information on multiple evaluation axes is used and units are different for each evaluation axis, such that it is difficult to simply specify and present occurrence causes of the problems.

Under such situations, JP 2006-146528 A discloses a management information display method for presenting management information related to reexamination of profitability to a user in order to secure the profitability of an enterprise. In the display method, loss and profit data of each goods stored in a storage device are read, each profit and loss amount obtained by rearranging goods in a descending order of a profit amount is displayed on a display device, when one of the goods is specified, loss and profit data and profit ratios by region for goods stored and designated in the storage device are read, and each loss and profit amount of the entire area rearranged in a descending order of the profit amount is displayed on the display device together with the profit ratio.

### SUMMARY OF THE INVENTION

As the prior art of a factor analysis, a lot of prior arts for narrowing down analysis targets to targets in which physical models are prone to a failure of equipment or the like have been suggested. However, with regard to the factor analysis by the department crossing, as an area of human judgment or an operation is increased, complexity of factors in the model is suddenly increased, comprehensiveness is lowered, such that there is a high possibility that the factor analysis is not right even if the factor is specified. To cope with such a problem, in the management information display method of JP 2006-146528 A, it is possible to analyze goods by region, but in enterprises dealing with a small quantity and various kinds of goods, specifying and presenting factors having a high influence degree across the department are not reviewed. However, in a business form dealing with various kinds of goods, many enterprises are worried that operations in each department are complicated and a profit does not come out as expected, and furthermore, when measures are implemented, since it is difficult to grasp improvement potential in each department or priority by the department crossing, there may be many cases in which the measures are not implemented or are individually optimized.

An object of the present invention is to provide a product narrowing down support system and method capable of solving the above problems in enterprises dealing with various kinds of goods and increasing influence degree management or measure implementation precision on the entire VC such as department crossing.

In order to solve the above problem, the present invention provides a product narrowing down support system in an enterprise dealing with various kinds of goods, including: a processing unit and a storage unit, in which the storage unit stores, as stored data, a product master table storing various kinds of goods, a management index database storing a management index of the enterprise and data thereof for each product, and a factor index database storing a factor index affected by multiple products and data thereof for each product, and the processing unit narrows down, by using the stored data, a product having a high influence degree on deterioration in the management index for each management index by VC crossing to specify a product of a target for which a measure is to be implemented.

In addition, in order to solve the above problem, the present invention provides a product narrowing down support method in an enterprise dealing with various kinds of goods, the product narrowing down support method executed by a system including a processing unit and a storage unit, including: storing, as stored data, a product master table storing various kinds of goods, a management index database storing a management index of the enterprise and data thereof for each product, and a factor index database storing a factor index of each department affected by multiple products and data thereof for each product in the storage unit, and narrowing down, by the processing unit, a product which greatly influences deterioration in the management index for each management index by VC crossing to specify a product of a target for which a measure is to be implemented.

According to the present invention, it is possible to narrow down a factor product having a high influence degree on deterioration in a management index for each management index by VC crossing to support specifying a product of a target for which a measure is to be implemented, in an enterprise dealing with various kinds of goods.

### BRIEF DESCRIPTION OF THE DRAWINGS

FIG. 1 is a diagram showing an example of an overall flow of a product narrowing down support system and method according to a first embodiment;

FIG. 2 is a hardware system configuration diagram of the product narrowing down support system according to the first embodiment;

FIG. 3 is a program configuration diagram of the product narrowing down support system according to the first embodiment;

FIG. 4 is a schematic diagram showing difficulty of businesses and management in an enterprise dealing with multiple products according to the first embodiment;

FIG. 5 is a diagram showing an example of a management index database according to the first embodiment;

FIG. 6 is a diagram showing an example of a factor index database according to the first embodiment;

FIG. 7 is a diagram showing an example of a product master according to the first embodiment;

FIG. 8 is a diagram showing an example of a processing flow of a correlation value and contribution ratio calculator according to the first embodiment;

FIG. 9 is a diagram schematically showing a calculation processing image of the correlation value and contribution ratio calculator according to the first embodiment;

FIG. 10 is a diagram showing an example of a processing flow of a contribution amount calculation step in the contribution amount calculator according to the first embodiment;

FIG. 11 is a diagram showing an example of a processing flow of a ranking calculation step in a ranking calculator for each department according to the first embodiment;

FIG. 12 is a diagram schematically showing a processing flow of a ranking calculation step of a sales decreasing factor in a contribution amount for product A according to the first embodiment;

FIG. 13 is a diagram showing a flow for specifying a factor product having a high influence degree on the entire VC (department) in a VC crossing ranking calculator and presenting the specified factor product as a target for which a measure is to be implemented according to the first embodiment; and

FIG. 14 is a diagram showing an output image to a display screen of a factor product having a strong influence on the management index and having a large improvement potential according to the first embodiment.

### DESCRIPTION OF THE PREFERRED EMBODIMENTS

Hereinafter, embodiments of the present invention will be described with reference to the accompanying drawings. In drawings showing a flow, steps of each flow are displayed as in S101, for example. In the present specification, VC is a value chain proposed in M. E. Porter's book “Competitive Advantage Strategy”, and means a framework for classifying business into main activity and support activity and analyzing which process creates added value (value). It includes department, a supply chain (SC) or the like.

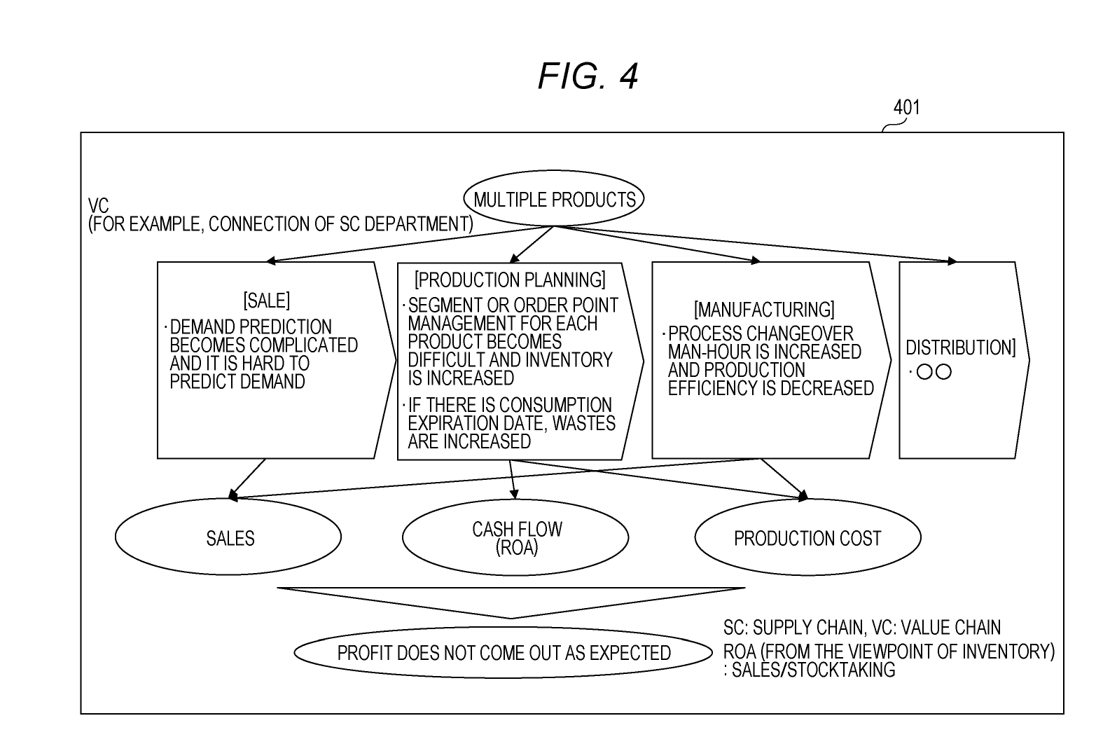

Prior to explaining embodiments of the product narrowing down support system and the like of the present invention, an example showing the difficulty of business and management in enterprises dealing with multiple products which is the problem to be solved by the present invention will be described with reference to FIG. 4. In FIG. 4, a connection of SC department is taken as an example and shown in VC 401. As schematically shown in FIG. 4, when an enterprise deals with various kinds of goods, there are problems in each process such as sale, production planning, manufacturing, and distribution. That is, in the case of multiple products, demand prediction becomes complicated in the sales department and process, and as a result it is hard to predict demand. In addition, in the production planning department and process, even if the enterprise plans for manufacturing of goods in consideration of how much inventory is kept for each product, segment management (standard setting of an inventory stock scale) for each product or order point management is complicated, and as a result inventory tends to be increased. Therefore, if there is a consumption expiration date, waste is increased. In addition, in the manufacturing department and process, process changeover man-hour is increased and production efficiency is decreased. As a result, the management indexes such as sales, cash flow (total return on assets: ROA), and production cost are affected in each step, and as a result a profit does not come out as expected. This is one of the common problems of enterprises dealing with various kinds of goods.

In embodiments described below, explanation will be given by exemplifying support for narrowing down products of factors having a high influence degree by department crossing in manufacturing industries that manufacture various kinds of goods. However, the present invention is applicable to product narrowing down support not only in manufacturing enterprises that manufacture goods, but also to enterprises of other businesses, organizations, or the like such as retail enterprises that sell various kinds of goods. Here, the term “multiple products” refers to thousands to tens of thousands of products that, for example, are difficult for a human to manage.

### First Embodiment

A first embodiment is an embodiment of a product narrowing down support system and method of factors having a high influence degree by department crossing in an enterprise producing various kinds of goods. That is, the first embodiment relates to a product narrowing down support system in an enterprise dealing with various kinds of goods and a product narrowing down support method. The product narrowing down support system includes a processing unit and a storage unit, in which the storage unit stores, as stored data, a product master table storing various kinds of goods, a management index database storing a management index of the enterprise and data thereof for each product, and a factor index database storing a factor index affected by multiple products and data thereof for each product, and the processing unit narrows down, by using the stored data, a product having a high influence degree on deterioration in the management index for each management index by VC crossing to specify a product of a target for which a measure is to be implemented.

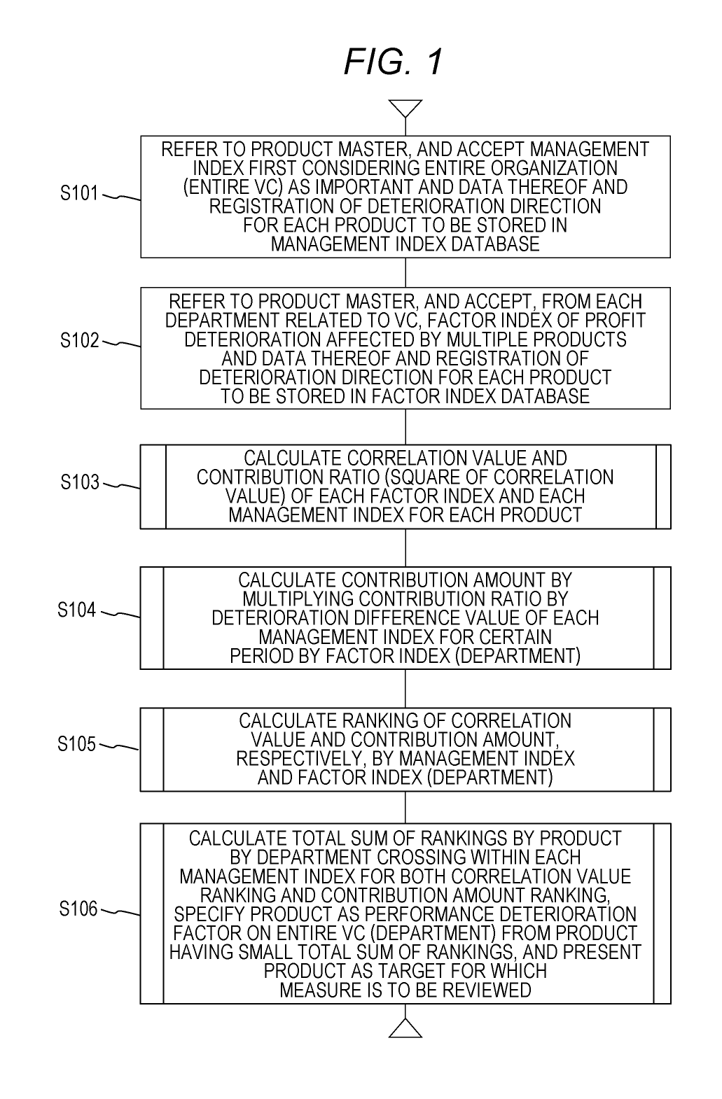

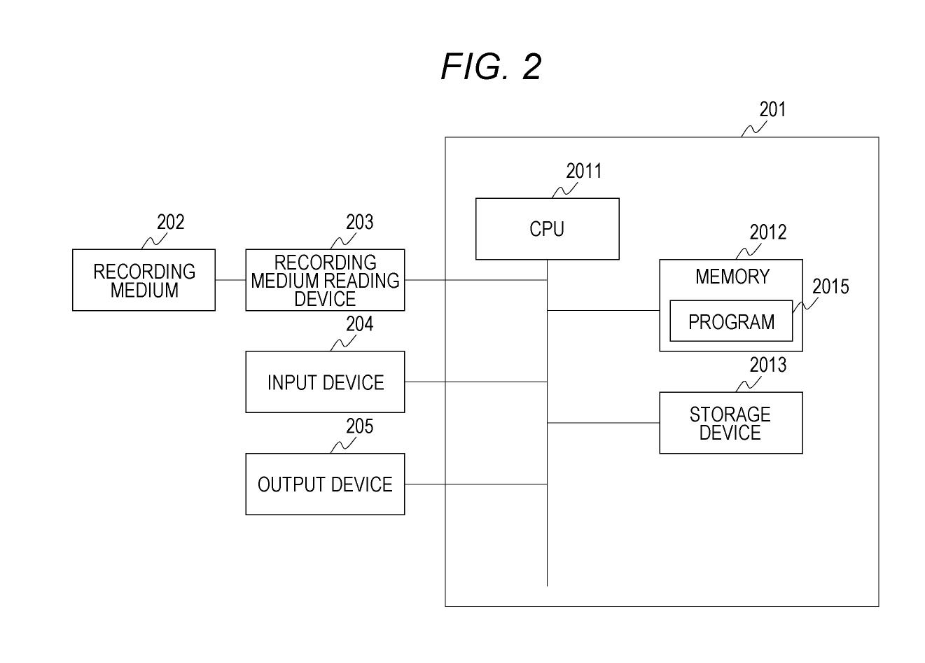

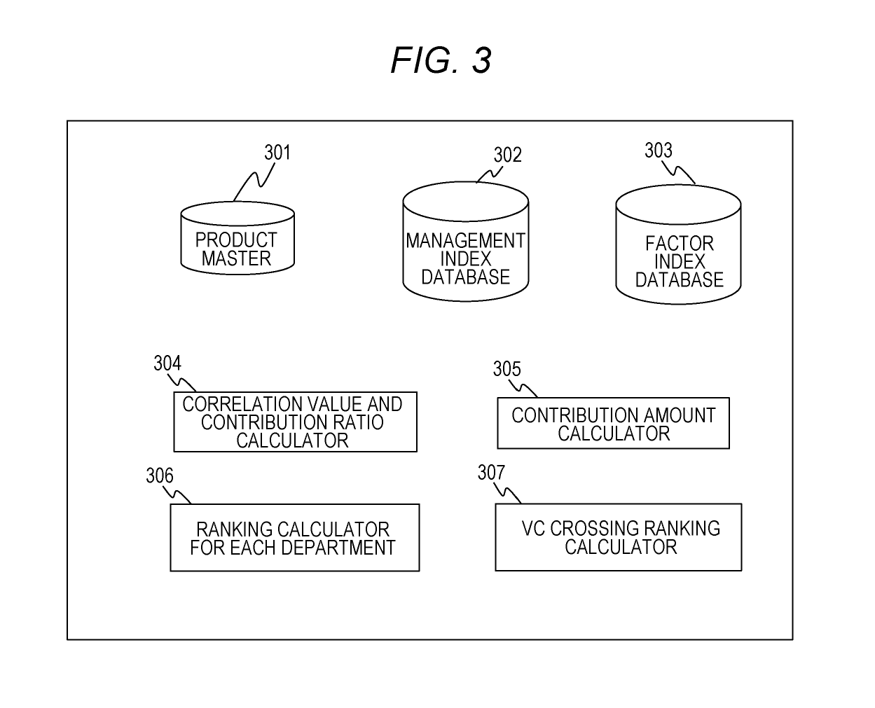

FIG. 1 is a diagram showing an example of an overall flow of a product narrowing down support system and method according to a first embodiment. FIGS. 2 and 3 are a hardware system configuration diagram and a program configuration diagram, respectively, of the product narrowing down support system of the present embodiment. As shown in FIG. 2, a hardware system of the product narrowing down support system includes a computer main body 201 such as a personal computer (PC), a recording medium 202 such as a magnetic tape, a recording medium reading device 203, an input device 204 such as a keyboard, and an output device 205 such as a display. The computer main body 201 includes a central processing unit (CPU) 2011 as a processing unit, and a storage device 2013 such as a memory 2012 or a hard disk drive (HDD) storing a program 2015 as a storage unit.

In addition, as shown in FIG. 3, the function of the product narrowing down support system includes a database such as a product master 301, a management index database 302, and a factor index database 303, and a calculator such as a correlation value and contribution ratio calculator 304, a contribution amount calculator 305, a ranking calculator for each department 306, a VC crossing ranking calculator 307, and the like. Various kinds of databases are stored in the recording medium 202 or the storage device 2013 in FIG. 2. In addition, various kinds of calculators can be realized by allowing the CPU 2011 to execute various kinds of programs 2015 stored in the memory 2012.

In the processing flow of the product narrowing down support system of the present embodiment shown in FIG. 1, the pre-stored product master 301 is referenced, and the management index first considering the entire organization (entire VC) as important and data thereof and a registration of a deterioration direction for each product are accepted to be stored in the management index database in FIG. 3 (S101). Next, the product master 301 is referenced, and a factor index of profit deterioration affected by multiple products and data thereof and a registration in a deterioration direction for each product are accepted from each department related to VC to be stored in the factor index database (S102).

Correlation values and contribution ratios (square of the correlation value) between each factor index and each management index for each product are calculated (S103). In addition, a contribution amount is calculated by multiplying a deterioration difference value of each management index for a certain period by the contribution ratio by factor index (department) (S104). In addition, the ranking in each of the correlation values and the contribution ratios is calculated for each management index and each factor index (department) (S105).

Finally, a total sum of rankings is calculated by product by the department crossing within each management index for both the correlation value ranking and the contribution amount ranking, and a product is specified as a factor product having a high influence degree on the entire VC (department) from a product having a small total sum of rankings and is presented as target for which measure is to be implemented (S106).

The processing flow of the product narrowing down support system is executed by the program of the CPU 2011 which is the processing unit, and the processing unit narrows down a product which greatly influences the deterioration in the management index for each management index by the VC crossing, such that it is possible to specify a product for which a measure is to be implemented.

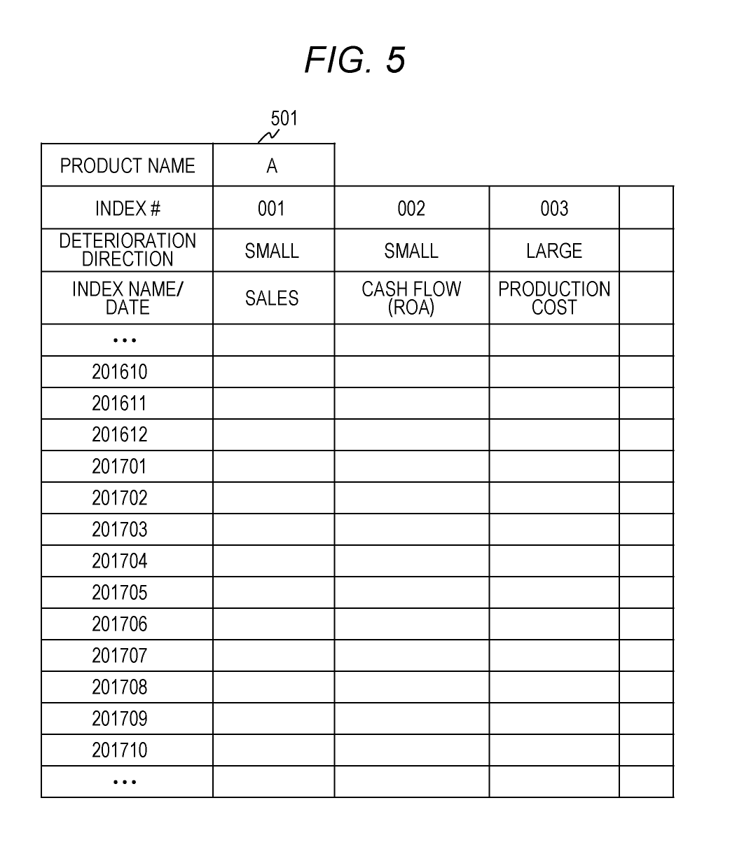

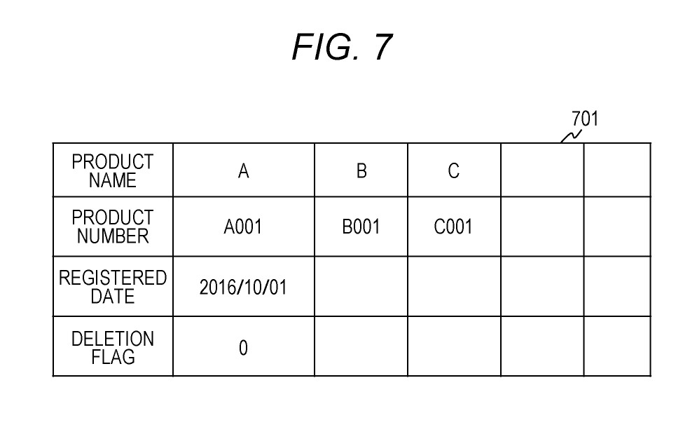

Hereinafter, details of each step of the processing flow of FIG. 1 will be sequentially described with reference to FIGS. 5 to 13. In the first step S101, a product name is referenced from a product master table 701 shown in FIG. 7, and a management index considering the entire organization (entire VC) as important and data thereof and a registration of a deterioration direction for each product are accepted to be stored in the management index database 302 in FIG. 3. FIG. 5 shows a management index data table 501 as an example of the management index database 302. As shown in FIG. 5, the management index data table 501 stores a product name, and index numbers (index #) indicating each management index, an index name, a deterioration direction thereof, and a date of management index data. In FIG. 5, the case in which monthly management index data of each year is stored is exemplified. In the column of the product name of the management index data table 501, product names A, B, and C, product numbers A001, B001, and C001, a registration date, a deletion flag, and the like registered in advance in the product master table 701 shown in FIG. 7 are referenced, and the products A, B, and C and the like are stored. In the column of the deterioration direction of the management index data table 501, a magnitude thereof indicates the deterioration directions of each management index. In other words, the storage unit such as a memory stores the deterioration direction of the management index of the management index database 302 as stored data.

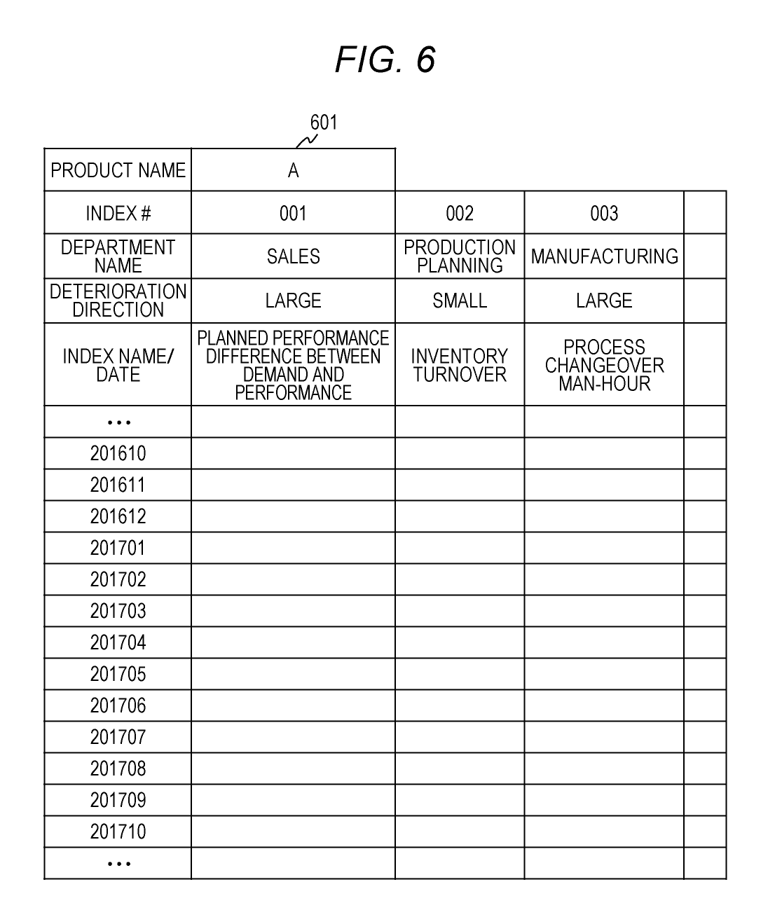

In the next step S102, as in S101, the product name is referenced from the product master table 701 shown in FIG. 7, and a factor index of profit deterioration affected by multiple products and data thereof and a registration in a deterioration direction for each product are accepted from each department related to VC to be stored in the factor index data table 601 shown in FIG. 6. The factor index data table 601 stores a product name, and stores index numbers (index #) indicating each factor index, a department name, an index name in which the department is registered, a deterioration direction thereof, and a date of factor index data. The department includes three departments of sale, production planning, and manufacturing, and as the factor index affected by multiple products corresponding to each department, a planned performance difference between demand and performance, an inventory turnover, and a process changeover man-hour are shown. In FIG. 5, the case in which monthly factor index data of each year is stored is exemplified. In the column of the deterioration direction of the factor index data table 601, a magnitude thereof indicates the deterioration directions of each factor index. In other words, the storage unit such as a memory stores the deterioration direction of the factor index of the factor index database as stored data.

In the subsequent step S103, the correlation value and contribution ratio calculator 304 of FIG. 3 calculates correlation values and contribution ratios (square of the correlation value) between each factor index and each management index for each product. That is, the processing unit uses the stored data to calculate the influence degree on the deterioration in the management indexes of each factor index by product stored in the product names of the management index data table 501 and the factor index data table 601, for example, the correlation value and the contribution ratio (square of the correlation value) between each factor index and each management index.

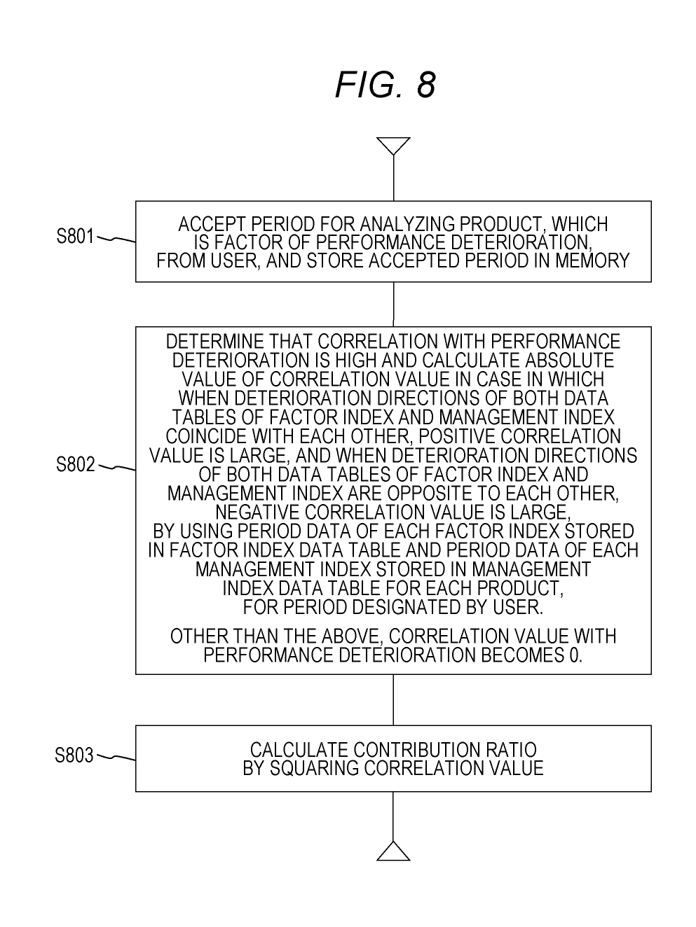

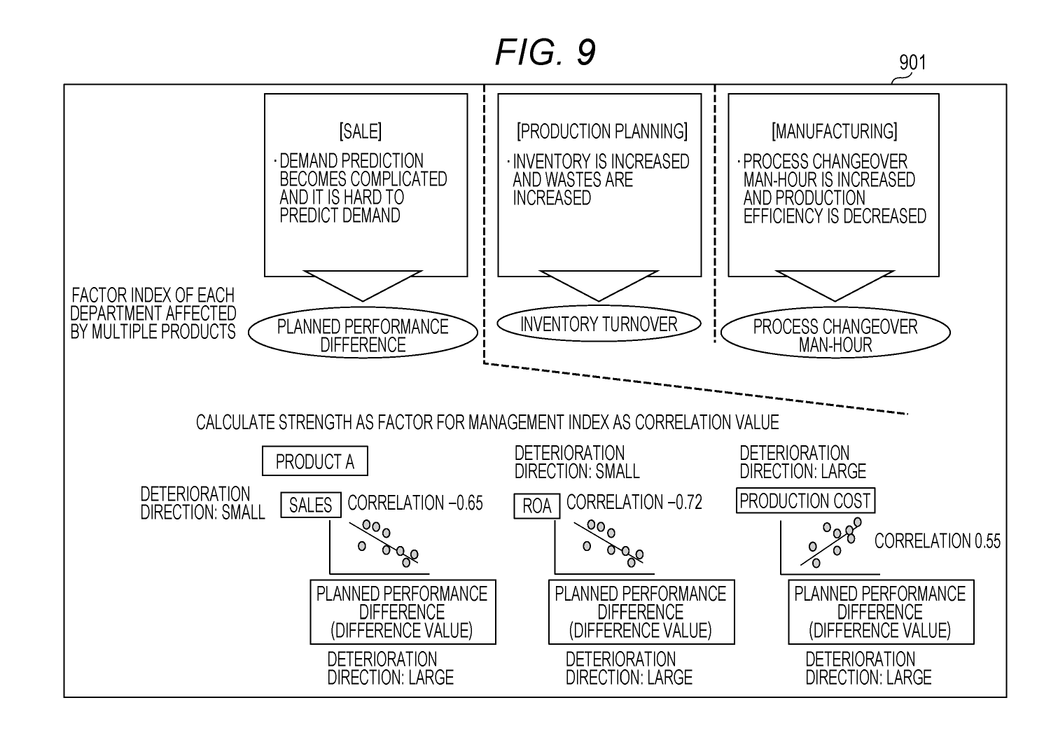

FIG. 8 shows a processing flow of the correlation value and contribution ratio calculator 304 in step 103, and FIG. 9 shows a calculation processing image. In the processing flow of FIG. 8, first, a period in which a product analysis is performed is accepted from a user and stored in the memory 2012 or the like (S801). Thereafter, by using, by product, the period data of each factor index stored in the factor index data table 601 and the period data of each management index stored in the management index data table 501, for the period designated by the user,

(i) when the deterioration directions of both the data tables of the factor index and the management index coincide with each other, it is determined that the correlation to the deterioration in both the indexes is high in the case in which a positive correlation value is large, and
(ii) when the deterioration directions of both the data tables of the factor index and the management index are opposite to each other, it is determined that the correlation to the deterioration in both the indexes is high in the case in which a negative correlation value is large,
such that the correlation value and contribution ratio calculator 304 calculates a correlation absolute value which is an absolute value of the correlation value, while having directionality of the influence on the deterioration of the factor index and management index. Except for the above two cases, it is impossible to give meaning to improving the deterioration of the factor index and to improving the deterioration of the management index, so the correlation value is set to 0 (S802). The contribution ratio is calculated by squaring the calculated correlation value. As described above, it is important to preset the deterioration direction of each of the management index and the factor index in the product narrowing down support system and method of this embodiment.

In a calculation processing image 901 of the correlation value and contribution ratio calculator 304 of FIG. 9, as an example of the planned actual difference which is the factor index of the sales department for product A, and the strength and the influence degree as a deterioration factor for the management index are shown as the correlation value. For example, a negative correlation value (−0.65) is calculated for sales which is the management index, a negative correlation value (−0.72) is calculated for ROA which is the management index, and a positive correlation value (0.55) is calculated for production cost which is the management index, which is an example in which the strength of the influence degree is digitized. Similarly, the correlation value as the influence degree on the deterioration in the management index is also calculated for the inventory turnover which is the factor index of the production planning department or the process changeover man-hour which is the factor index of the manufacturing department and the like, respectively.

Here, the determination on the deterioration direction in S802 will be described in detail. The sales of the management index deteriorates if “small” as shown in the deterioration direction of the management index data table 501, and the planned performance difference which is the factor index of the sales department deteriorates if “large” as shown in the factor index data table 601. The directionality of the deteriorations of the two indexes is opposite. Therefore, in the data distribution shown in FIG. 9, in the case in which sales tends to become small when the negative correlation is generated, that is, when the planned performance difference becomes large, it is determined that the factor index related to the planned performance difference affects the deterioration in the management index related to sales.

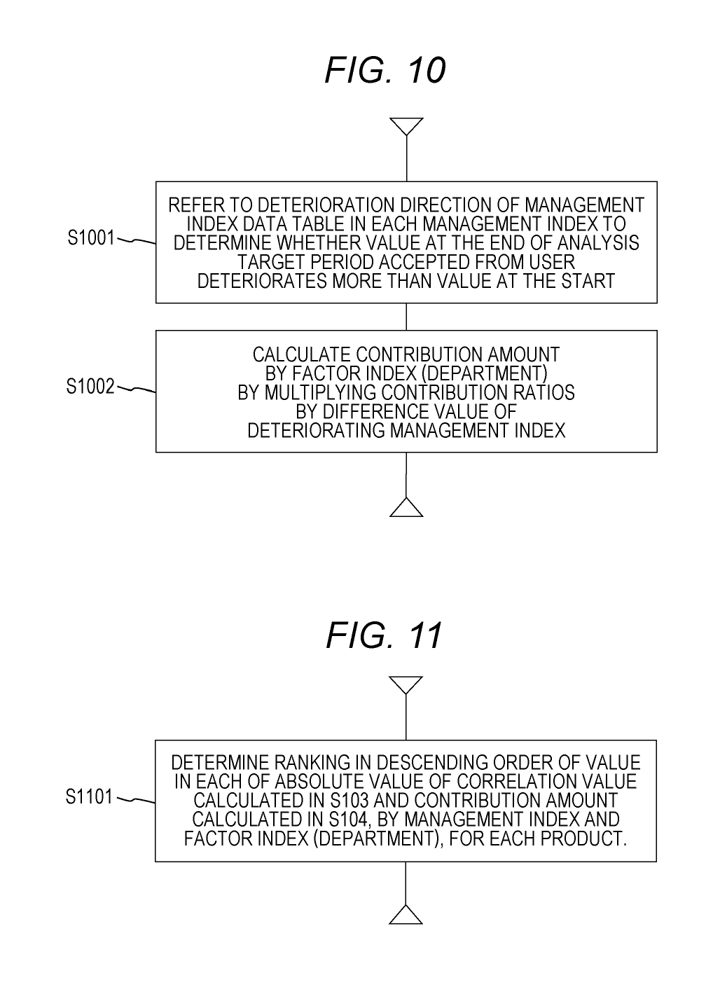

In the subsequent step S104, the contribution amount is calculated by multiplying the deterioration difference value of each management index for a certain period by the calculated contribution ratio by factor index of each department. That is, the processing unit uses the stored data to calculate the contribution amount from the deterioration difference value and the contribution ratio of the management index for a certain period by factor index. FIG. 10 shows details of the contribution amount calculation step S104 performed by the contribution amount calculator 305. As shown in FIG. 10, in S1001, the deterioration direction of the management index data table 501 is referenced in each management index to determine whether the value of the corresponding management index in management index data table 501 at the end of analysis target period accepted from a user deteriorates more than the value at the start. Next, the contribution amount calculator 305 multiplies the difference value of the deteriorating management index by the contribution ratio by factor index of each department to calculate the contribution amount (S1002).

After calculating the contribution amount, in step S105, the ranking calculator for each department 306 calculates rankings for each correlation value and contribution ratio by management index and factor index That is, the processing unit calculates the ranking order by each correlation value and contribution amount by management index and factor index. As shown in step S1101 of FIG. 11, the ranking is determined in a descending order of the value by the absolute value of the correlation value calculated in S103 and the contribution amount calculated in S104, respectively, by management index and factor index (department), for each product.

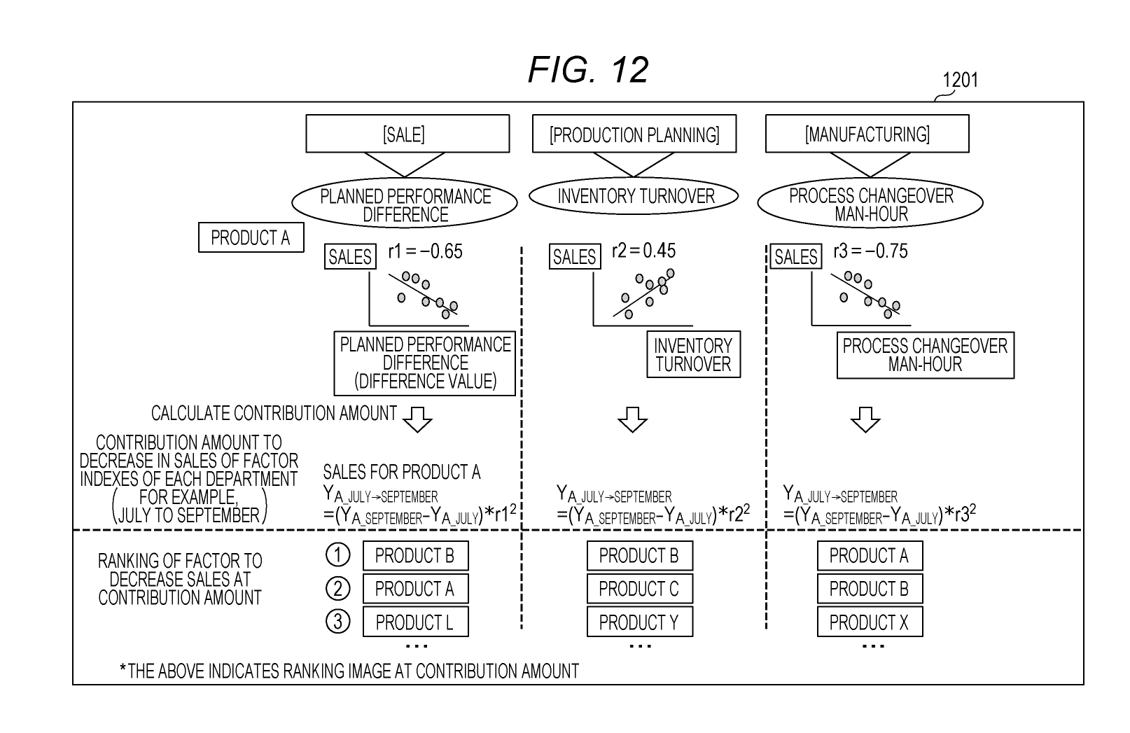

FIG. 12 schematically shows the ranking determination of a sales decreasing factor in a contribution amount for product A. First, in S802, correlation values r1, r2, and r3 of the planned performance difference, the inventory turnover, and the process changeover man-hour and sales are calculated. The planned performance difference, the inventory turnover, and the process changeover man-hour are the factor indexes of the departments of sale, production planning, and manufacturing, respectively. Then, as shown in the calculation processing image 1201, the ranking calculator for each department 306 uses a square of a contribution ratio r1, a square of a contribution ratio r2, and a square of a contribution ratio r3 which are calculated in S803, and when sales of product A, for example, from July to September coincides with “small” shown in a deterioration direction of the management index data table 501 and is decreased, the contribution amount to the decrease in sales of the factor indexes of each department is calculated using a calculation equation shown in FIG. 12, for example. Specifically, in the sales department, the contribution amount to the decrease in sales of the factor index which is the difference in planned performance of product A is calculated by multiplying the difference value of sales deteriorated from July to September by the square of r1. The ranking calculator for each department 306 uses each of the calculated contribution amounts to prepare the sales decreasing factor ranking so that the larger the contribution amount of the product, the higher the ranking of the product. FIG. 12 shows an example in which products are ranked in each department as in the case in which for example, in the sales department, product B has the largest contribution amount, product A has the second largest contribution amount, product L has the third largest contribution amount, . . . , and the like.

Here, the contribution amount may be calculated by multiplying the deterioration difference value of the management index by the correlation value or the like. In the present embodiment, the contribution amount is calculated as the improvement potential against the deterioration in the management index, and since the contribution ratio has a mathematical characteristic showing certainty of data, when the factor index deteriorates, the management index is equal to a ratio of deteriorating data, such that the improvement potential is calculated by multiplying the difference value of the management index.

After the rankings for each department in the correlation value and the contribution ratio are calculated, in step S106, the VC crossing ranking calculator 307 calculates a total sum of rankings by the department crossing for each product within each management index for both the correlation value ranking and the contribution amount ranking, and specifies a product as a factor product having a high influence degree on the entire VC (department) from a product having a small total sum of rankings and presents the product as a target for which measure is to be reviewed. That is, the processing unit calculates the total sum of rankings by product by the VC crossing within each management index for the ranking order of the correlation value or the contribution amount, and specifies a product for which a measure is to be implemented based on a product having the small total sum of rankings calculated.

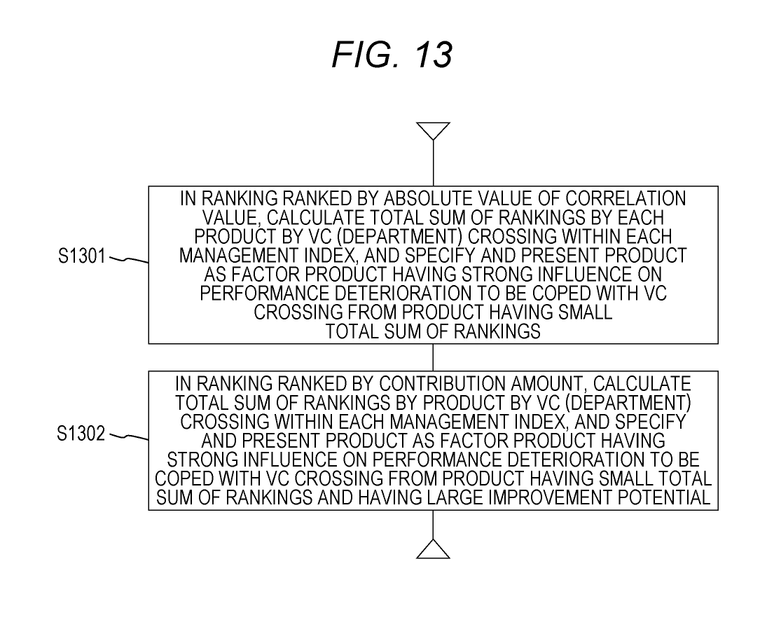

FIG. 13 shows an example of the processing flow. In S1301, the VC crossing ranking calculator 307 calculates the total sum of rankings by product by the VC (department) crossing within each management index in the ranking ranked by the absolute value (correlation absolute value) of the correlation value, and specifies and presents a product as the factor product having the strong influence on the deterioration in the management index to be coped with the VC crossing from the small total sum of rankings. Next, in step S1302, the VC crossing ranking calculator 307 calculates the total sum of rankings by product by the VC (department) crossing for each management index in the ranking ranked by the contribution amount, and specifies and presents a product as the factor product having the strong influence on the deterioration in the management index and the large improvement potential to be coped with the VC crossing from the small total sum of rankings.

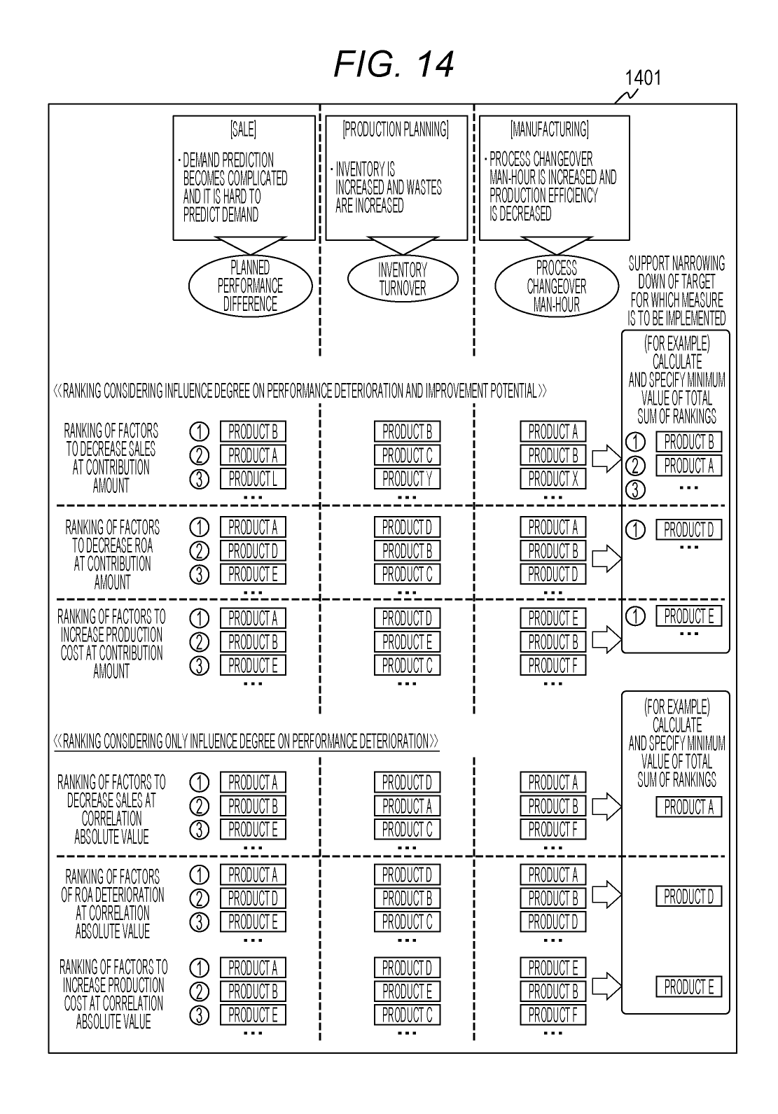

FIG. 14 shows an output image 1401 on the display screen of the output device 205 in FIG. 2, as an example of the factor product having the strong influence on the deterioration in the management index and the large improvement potential, which is calculated and presented by the VC crossing ranking calculator 307. As shown in the output image 1401, the ranking considering the influence degree on the deterioration in the management index and the improvement potential for the planned performance difference, the inventory turnover, and the process changeover man-hour which are the factor indexes of the departments of sale, production planning, and manufacturing, respectively, and the results obtained by narrowing down a target, for which a measure is to be implemented, specified by calculating the minimum value of the total sum of rankings are shown on an upper end of the output image 1401. The ranking is shown by sales decreasing factor ranking in a contribution amount, ROA deterioration factor ranking in a contribution amount, and production cost increasing factor ranking in a contribution amount. As shown on the upper end, for example, the sales decreasing factor ranking in the contribution amount is an example of output in an order of product B, product A, and product L for the planned performance difference which is the factor index of the sales department, an order of product B, product C, and product Y for the inventory turnover of the production planning department, and an order of product A, product B, and product X for the process changeover man-hour of the manufacturing department. It is possible to obtain product B, product A, . . . , and the like as results for supporting the narrowing down of the target for which the measure is to be implemented by calculating the minimum value of the total sum of rankings by product by the department crossing within each management index. For example, in the sales decreasing factor ranking in the contribution amount, since the product B is a first rank in the sales department, a first rank in the production planning department, and a second rank in the manufacturing department, when viewed by the department crossing, the total sum of rankings in 4 of first rank+first rank+second rank becomes minimum, and when viewed by the VC crossing, the strength of influence on the lowest sales and the improvement potential upon implementing measures become high. It is possible to perform a similar narrowing down support based on the ROA deterioration factor ranking and the production cost increasing factor ranking in the contribution amount.

A lower end of FIG. 14 shows the rankings based only on the influence degree on deterioration of the management index for the planned performance difference, the inventory turnover, and the process changeover man-hour which are the factor indexes of the departments of sale, production planning, and manufacturing, respectively. The lower end is an example of an output presented in product A, product D, and product E, respectively, based on the sales decreasing factor ranking in the correlation absolute value which is the absolute value of the correlation value, the ROA deterioration factor ranking in the correlation absolute value, and the production cost increasing factor ranking in the correlation absolute value.

As described above, according to the product narrowing down support system and method of the present embodiment, it is possible to narrow down the product, which is the deterioration factor in the management index in the manufacturing industries dealing with various kinds of goods, for each management index by the VC crossing, and support specifying the target for which the measure is to be implemented. As described above, this embodiment exemplifies and describes the manufacturing industries that manufacture various kinds of goods, but can also be applied to the VC in enterprises of other businesses such as retail business dealing with various kinds of goods, perform narrowing down on each management index by the VC crossing, and support specifying the target for which the measure is to be implemented.

That is, the present invention is not limited to the above-described embodiments, but includes various modified examples. For example, the above-described embodiments have been described in detail for a better understanding of the present invention, and are not necessarily limited to those having all the configurations of the description. In addition, it is possible to replace a part of the configuration of one embodiment with the configuration of another embodiment, and add the configuration of another embodiment to the configuration of one embodiment. Further, it is possible to add, delete, and replace other configurations with respect to part of the configuration of each embodiment.

In addition, although the above-described configurations, functions, processing units, and the like have described examples of preparing programs that realize some or all of them, it goes without saying that some or all of them can be realized by hardware such as being designed by, for example, an integrated circuit. That is, the functions of all or a part of the processing units such as various kinds of calculators may be realized by an integrated circuit such as application specific integrated circuit (ASIC), field programmable gate array (FPGA), and the like, instead of the program.

What is claimed is:

1. A product narrowing down support system in an enterprise dealing with various kinds of goods, comprising:
a processing unit; and
a storage unit,
wherein the storage unit stores, as a stored data,
a product master table storing the various kinds of goods,
a management index database storing a management index of the enterprise and data thereof for each product, and
a factor index database storing a factor index affected by multiple products and data thereof for each product, and
the processing unit narrows down, by using the stored data,
a product having a high influence degree on deterioration in the management index for each management index by a value chain (VC) crossing to specify a product of a target for which a measure is to be implemented.

2. The product narrowing down support system according to claim 1, wherein
the processing unit specifies an influence on deterioration in the management index by product based on strength of influence on the deterioration in the management index of the factor index affected by multiple products in each department of the VC, and further calculates the influence by product for the management index by VC crossing to thereby specify a product of a target for which the measure is to be implemented.

3. The product narrowing down support system according to claim 2, wherein
the processing unit specifies the influence on the deterioration in the management index based on the strength of the influence of the factor index on the deterioration in the management index, and based on a contribution amount expected to improve upon implementing of a measure in each department of the VC, by product of multiple products and the influence on each product by the VC crossing calculates ranking of a product,
to specify the product of the target for which the measure is to be implemented.

4. The product narrowing down support system according to claim 1, wherein
the storage unit stores, as the stored data, deterioration directions in the management index and the factor index in the management index database and the factor index database, respectively.

5. The product narrowing down support system according to claim 4, wherein
the processing unit uses the stored data to calculate influence degree on the deterioration in the management index of each of the factor indexes by product stored in the product master table.

6. The product narrowing down support system according to claim 5, wherein
the processing unit uses the stored data to calculate a correlation value and a contribution ratio of the factor index and the management index by product as the influence degree.

7. The product narrowing down support system according to claim 6, wherein
the processing unit uses the stored data to calculate a contribution amount from a deterioration difference value and the contribution ratio of the management index for a certain period, by factor index, and calculates ranking order by management index and factor index in each of the correlation value and the contribution amount.

8. The product narrowing down support system according to claim 7, wherein
the processing unit uses the stored data to calculate a total sum of rankings by product by the VC crossing within each management index for the ranking order of the correlation value or the contribution amount, and specifies a product for which the measure is to be implemented based on a product having the small total sum of rankings calculated.

9. The product narrowing down support system according to claim 8, further comprising:
a display unit,
wherein the processing unit displays the specified product, for which the measure is to be implemented, by management index.

10. A product narrowing down support method in an enterprise dealing with various kinds of goods, the product narrowing down support method executed by a system including a processing unit and a storage unit, comprising:
storing, as stored data, a product master table storing various kinds of goods, a management index database storing a management index of the enterprise and data thereof for each product, and a factor index database storing a factor index for each department affected by multiple products and data thereof for each product in the storage unit, and
narrowing down, by the processing unit, a product which greatly influences deterioration in the management index for each management index by VC crossing to thereby specify a product of a target for which a measure is to be implemented.

11. The product narrowing down support method according to claim 10, wherein
the management index database and the factor index database each store deterioration directions in the management index and the factor index as the stored data.

12. The product narrowing down support method according to claim 11, wherein
the processing unit uses the stored data to calculate the influence degree on the deterioration in the management index of each of the factor indexes by product stored in the product master table.

13. The product narrowing down support method according to claim 12, wherein
the processing unit uses the stored data to calculate a correlation value and a contribution ratio of the factor index and the management index by product as the influence degree.

14. The product narrowing down support method according to claim 13, wherein
the processing unit uses the stored data to calculate a contribution amount by factor index from a deterioration difference value and the contribution ratio of the management index for a certain period, and calculates ranking order by management index and factor index in each of the correlation value and the contribution amount.

15. The product narrowing down support method according to claim 14, wherein
the processing unit uses the stored data to calculate a total sum of rankings by each product by the VC crossing within each management index for the ranking order of the correlation value or the contribution amount, and specifies a product for which the measure is to be implemented based on a product having the small total sum of rankings calculated.
